(19) United States
(12) Patent Application Publication
(10) Pub. No.: US 2026/0058972 A1
(43) Pub. Date: Feb. 26, 2026

(54) Parental Monitoring of In-App Communications

(71) Applicant: David Everitt, JR., Anthem, AZ (US)

(72) Inventor: David Everitt, JR., Anthem, AZ (US)

(21) Appl. No.: 19/309,350

(22) Filed: Aug. 25, 2025

Related U.S. Application Data
(60) Provisional application No. 63/686,653, filed on Aug. 23, 2024.

(51) Int. Cl. H04L 9/40; G06Q 50/26

(52) U.S. Cl. CPC H04L 63/1425; G06Q 50/265

(57) ABSTRACT

A child computing device runs at least one app, such as a gaming app, a messaging app, social media app, and the like. A background application also runs on the child computing device and periodically takes samples of what the child is exposed to on the computing device, including samples of voice (which is converted to text), video streams (which are split into frames), and screenshots having text. A cloud computing platform provides services for machine learning (ML) to analyze the samples to ascertain a likelihood that the samples have threats (e.g., bullying or sexual predation). If it appears likely, the app is disabled and a notification is sent to a parental monitoring application along with a copy of the offensive sample. The parent can override the determination and the app is re-enabled. The parent's action is fed back to ML which learns from the feedback.

### CROSS-REFERENCE TO RELATED APPLICATIONS

This application claims the benefit of U.S. Provisional Application No. 63/686,653, filed Aug. 23, 2024, which application is hereby incorporated herein by reference, in its entirety.

### TECHNICAL FIELD

The present invention relates to computer video games, messaging apps, and social media (collectively “apps”) and, more particularly, to parental monitoring of in-app communications.

### BACKGROUND

Most multiplayer online games, messaging apps, and social media (collectively “apps”) provide in-app communication, also referred to as chat capability. For example, in the context of online games, chat generally refers to a group of players exchanging text messages that are displayed in a scrollable area of the screen. To facilitate the flow of a conversation, each message is shown next to the player's username. Messages are displayed as they are received.

Chatting has its own slang and acronyms. As an example, instead of saying “You look great”, the sentence “U look gr8” might be used. Various acronyms such as “lol” (laugh out loud), “fwiw” (for what it's worth), and “tyvm” (thank you very much), are also frequently used. Chat lingo can also have “hidden meaning” such as the phrase “Netflix and chill” which sometimes is used as a euphemism for sexual activity.

Although in-app communication can be fun and exciting, sometimes one or more participants are disruptive by bullying, or even acting in a sexually predatory manner (collectively, “threats”). In the case of the sexual predator, the user may be an adult who is posing as a teen to lure a minor. There are extreme cases of suicide linked to cyberbullying and molestation or worse in the case of sexual predation. To address the foregoing, some online apps provide a degree of message filtering. However, message filtering is limited to filtering out offensive words or phrases. Message filtering doesn't address the underlying semantics of the chat interactions and regional differences in usages and meanings that might exist, much less with auditory and video threats.

Thus, the need has arisen for systems and methods that can provide more powerful filters for threats that arise in textual, audible, and video contexts.

### SUMMARY

A child computing device runs at least one app, such as a gaming app, a messaging app, social media app, and the like. A background application also runs on the child computing device and periodically takes samples of what the child is exposed to on the computing device, including samples of voice (which is converted to text), video streams (which are split into frames), and screenshots having text. A cloud computing platform provides services for machine learning (ML) to analyze the samples to ascertain a likelihood that the samples have threats (e.g., bullying or sexual predation). If it appears likely, the app is disabled and a notification is sent to a parental monitoring application along with a copy of the offensive sample. The parent can override the determination and, in this case, the user app running on the child computing device is re-enabled. The parent's action either to override the determination or to let it stand is then fed back to the ML model so that the ML model continues to learn the semantics of in-app communication based on the parental feedback.

In another embodiment, a background application runs on a child computing device and periodically takes screenshots, video clips, and audible threats which are samples of what the child is exposed to. If, by way of example, the child is playing a video game, text can be extracted from the screenshot within areas of the screen that chat is known to be displayed for the particular game. A cloud computing platform provides services for machine learning (ML) to analyze the chat text to ascertain a likelihood that the chat includes threats, such as bullying or sexual predation. If it appears likely, the game, or app, is disabled and a notification is sent to a parental monitoring application along with a copy of the offensive chat. The parent can override the determination and, in this case, the user application running on the child computing device is re-enabled. The parent's action either to override the determination or to let it stand is then fed back to the ML model so that the ML model continues to learn the semantics of in-app communication based on the parental feedback.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates an example system for monitoring multi-user in-app communications in accordance with principles of the invention;

FIG. 2 exemplifies steps for logging into the system of FIG. 1;

FIGS. 3A and 3B illustrate an example data flow diagram used in an implementation of the system for monitoring a multi-user online app chat, according to an embodiment;

FIG. 4 illustrates an example mobile device screen showing an example in-app communication, according to an embodiment;

FIG. 5 illustrates an example parental monitoring screen, according to an embodiment; and

FIG. 6 illustrates a block diagram showing the architecture of a computing device useable in conjunction with the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

As used herein, the term “app” or “apps” or “user app” or “user apps” refers to one or more online, multi-user applications having communication functionality. The term “threat” is used herein to refer to any danger that a child may encounter while on an app, such as cyberbullying, hate speech, sextorting, sexual predation (including molestation and worse), grooming, and the like. The term “substantially” is to be construed as a term of approximation.

It is noted that, unless indicated otherwise, functions described herein may be performed by a processor such as a microprocessor, a controller, a microcontroller, an application-specific integrated circuit (ASIC), an electronic data processor, a computer, or the like, in accordance with code, such as program code, software, integrated circuits, and/or the like that are coded to perform such functions. Furthermore, it is considered that the design, development, and implementation details of all such code would be apparent to a person having ordinary skill in the art based upon a review of the present description of the invention.

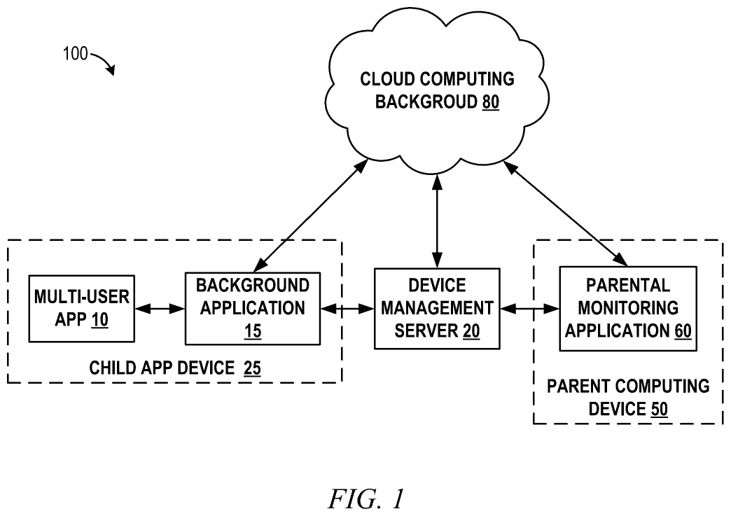

Referring to FIG. 1 of the drawings, the reference numeral 100 generally designates an example system for monitoring multi-user online chat, also referred to as in/app, according to one embodiment. As shown, the example system 100 for monitoring apps includes a child computing device 25, a parent computing device 50, a device management server 20, and a cloud computing platform 80. The child computing device 25 and the parent computing device 50 can be a smartphone, a tablet, a laptop, a desktop, or the like. The child computing device 25 executes various foreground user applications and a background application 15 is associated with the user applications. The user applications can include one or more apps 10 running on the child computing device 25. The device management server 20 establishes a hierarchical relationship between the parental computing device 50 and the child computing device 25 such that the parent computing device 50 can control the child computing device 25, including the ability to disable (or re-enable) an application executing on the child computing device 25. An example of such commercially available device management server is Cisco Meraki by Cisco Systems, Inc.

The cloud computing platform 80 can include a suite of services executed remotely via the Internet. As used generally, “cloud computing” refers to accessing via the Internet storage and processes that reside remotely, as opposed to doing so on local or locally networked computing devices. Examples of such commercially available cloud computing services include Amazon Web Services (AWS) from Amazon.com, Inc.; Microsoft Azure from Microsoft Corporation; Google Cloud Platform from Google LLC; and IBM Cloud from IBM Corporation.

As will be described in greater detail below, the background application 15 takes screenshots from the child computing device 25 periodically, which are samples of what the child is viewing. If a screenshot corresponds to a supported app being executed on the child computing device 25, it will be sent to the cloud computing system 80 along with metadata including the app platform (e.g., Minecraft Pocket 1.16.21 for Android), timestamp, and user ID. (However, depending on the operating system (e.g., Apple IOS), the identity of the currently running app may not be available, in which case the cloud-based platform 80 will have to analyze the screenshot to determine whether it corresponds to a supported app (e.g., a video game).

For screenshots matching supported apps, the cloud computing platform 80 determines the location of the chat text within the screenshot based on the identified app platform and known bounded areas (of the screen where chat is located for the app platform), and extracts the chat text into a file which is then stored. Thereafter, a machine learning (ML) model is instantiated based on the identified game and a geographic region. The ML model intelligently analyzes each line of chat to assess a likelihood that the chat is a threat (e.g., bullying or sexually predatory). If the likelihood value exceeds a predetermined threshold, the current user app (e.g., video game) running on the child computing device 25 is disabled and a notification is sent to a parental monitoring application 60 to this effect along with a copy of the offensive chat. A parent can override the determination, and in that case, the user application running on the child computing device 25 is re-enabled. The parent's action either to override the determination or to let it stand is then fed back to the ML model so that the ML model continues to learn the semantics of in-app communication based on the parental feedback. It is to be understood that although the word “parent” is used herein, any person in the role of being responsible for the child, including a teacher, a babysitter, a legal guardian, or another adult family member, may use the parental monitoring application in the same way as a parent. Furthermore, although the word “child” is used herein, any person in need of such supervision may be monitored in the same way as the child.

The example system 100 for monitoring app 10 described herein includes a distributed application which is partitioned between a service provider (cloud computing platform 80) and a service requester (parental computing device 50). Under this arrangement, a request-response protocol, such as hypertext protocol (HTTP), can be employed such that a requester (parental computing device 50) can initiate requests for services from the service provider (cloud computing platform 80), and the service provider (cloud computing platform 80) can respond to each respective request by, for example, performing a service, and (where appropriate) sending results to the client (parental computing device 50). It is to be understood that in some embodiments, however, substantial portions of the application logic may be performed on the requester side using, for example, the AJAX (Asynchronous Javascript and XML) paradigm to create an asynchronous web application. Furthermore, it is to be understood that in some embodiments one or more services can be distributed among a plurality of different servers (not shown).

In the present description of the present invention, example methods for performing various aspects of the present invention are disclosed. It is to be understood that the steps illustrated herein can be performed by executing computer program code written in a variety of suitable programming languages, such as C, C++, C#, Visual Basic, and Java. It is also to be understood that the software of the invention will preferably further include various Web-based applications that can be written in HTML, PHP, Javascript, jQuery, etc., accessible by the clients using a suitable browser (e.g., Internet Explorer, Microsoft Edge, Mozilla Firefox, Google Chrome, Safari, Opera) or as an application running on a suitable mobile device (e.g., an iOS or Android “app”).

As mentioned herein, machine learning (ML) is employed as a service by the cloud computing platform 80 to determine the semantic meaning of in-app communication. ML can include text classification, for example, to tag words or phrases, or combinations thereof, indicative of threats, such as bullying or predatory comments. The ML model chosen can employ deep learning algorithms such as a convolutional neural network (CNN) or a recurrent neural network (RNN), a support vector machine (SVM), or a Bayesian Network. Moreover, the ML model can be a hybrid including one or more categories of algorithm, e.g., a rules-based algorithm and an ML model. The ML model can be implemented using various available software tools such as Amazon Sagemaker Studio which is an integrated development environment (IDE) for machine learning, available through Amazon Web Services (AWS).

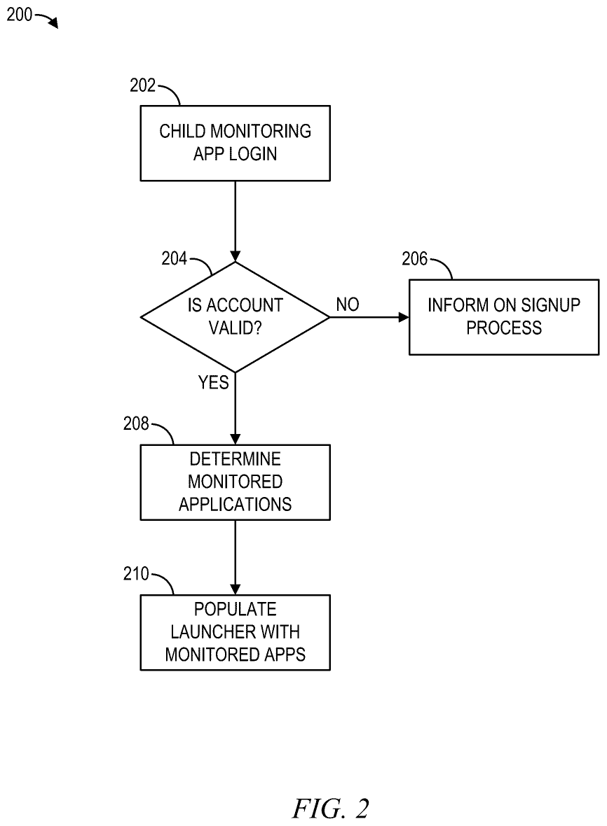

Referring to FIG. 2, a flow chart 200 depicts example steps for logging into the system 100. Accordingly, in step 202, a child attempts to login, which includes the entry of the child account number. In step 204, a determination is made by cloud computing platform 80 whether the child account is valid. If the account is held not valid (step 206), the child is precluded from logging into the app. If in step 204 the account is found to be valid, then in step 208, a determination is made of which apps are monitored. In step 210, a launcher on the child computing device 25 is populated with the monitored apps.

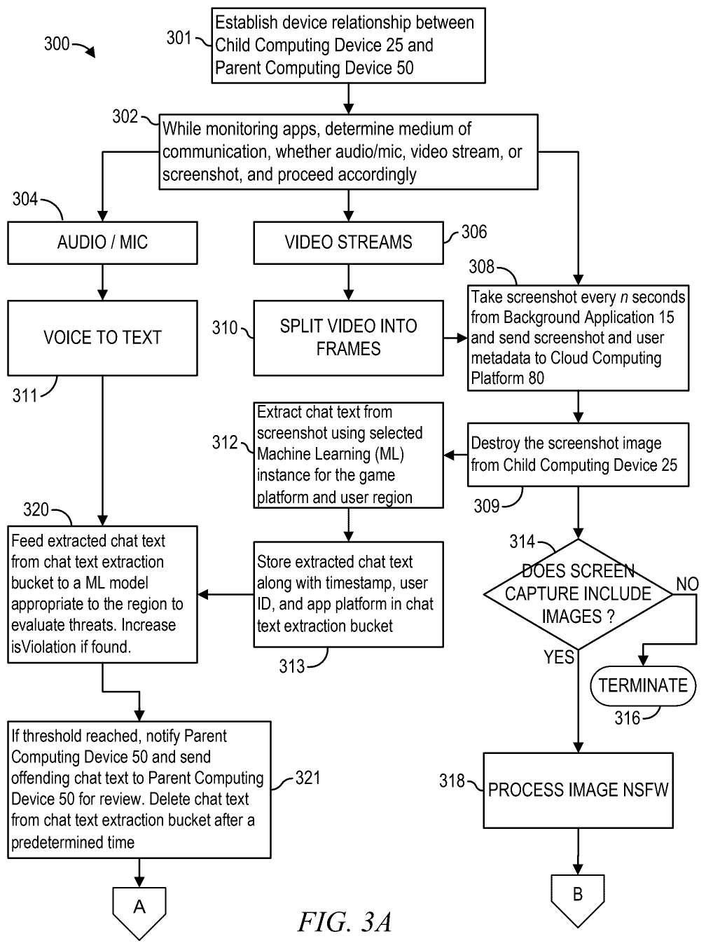

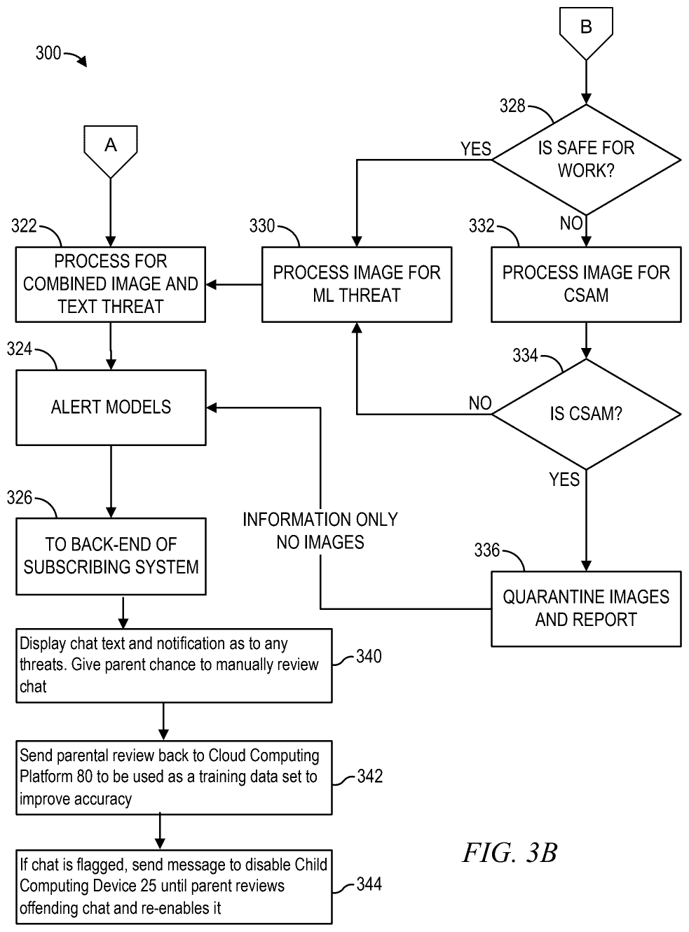

Referring to FIGS. 3A and 3B, an example data flow diagram 300 used in an implementation of system 100 for monitoring in-app communications is depicted.

In step 301, the device management server 20 establishes a “master/slave” relationship between the child computing device 25 and the parent computing device 50. This relationship allows the parent computing device 50 to control the child computing device 25.

In step 302, while monitoring apps, a determination is made whether a medium of communication is via audio/mic, video stream, or a screenshot, and to proceed accordingly to steps 304, 306, or 308, respectively.

If to step 308, then the background application 15 takes screenshots from the child computing device 25 periodically. Depending on the operating system (e.g., Apple IOS), the cloud-based platform 80 may have to analyze the screenshots to determine whether they match a particular game. In most cases (e.g., Android, Windows) the currently running process will be known, and if it matches a supported game platform, the child computing device 25 sends the screenshot along with metadata including the app platform, user ID, and timestamp to the cloud computing platform 80. The table below summarizes the information passed to the cloud-based platform 80 for Android/Windows and iOS operating systems.

TABLE 1

| Android/Windows | iOS |
|---|---|
| Bypass Special step for iOS that | Sends to Special step preceding |
| precedes step 312. If current | step 312 via a REST call: Screenshot |
| process matches a supported game, | image file with metadata including |
| sends to Step 312 via a REST call: | user ID and timestamp. Executes Step |
| Screenshot image file with | 312 after Special step below unless |
| metadata including user ID, | screenshot is found not to be |
| timestamp, app platform. | associated with a supported app. |

At step 309, once an HTTP 200 status is received indicating that the REST call to the cloud-based platform 80 was successful, the screenshot copy on the child computing device 25 is destroyed.

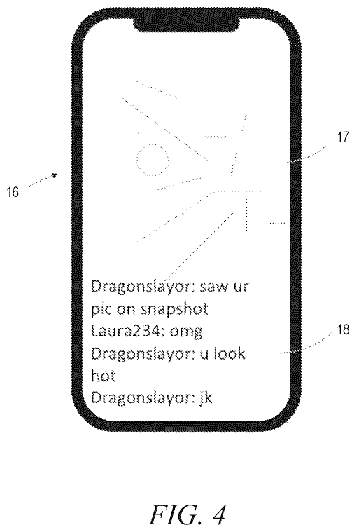

This is a special step that may need to be performed by users of iOS prior to step 312. Accordingly, step image recognition is performed on the screenshot to determine the game platform and vectors needed to extract the chat text. If the game platform is not recognized, the screenshot is destroyed and the process waits for an in-subscription screenshot. FIG. 4, illustrates an example screenshot 16. The example screenshot 16 includes a game play portion 17 and a chat portion 18.

At step 312, chat text is extracted from the screenshot using a selected machine learning (ML) instance for the app platform and user region. From the app platform, the bounded areas of the image where the chat box are known to be located are scanned using Optical Character Recognition (OCR) or similar techniques.

At step 313, the extracted chat text is stored along with the timestamp, user ID, and app platform in a chat text extraction bucket.

At step 320, the chat text from chat text extraction bucket is fed to a Machine Learning (ML) model appropriate to the geographic region to evaluate threats, such as bullying and predatory attempts.

At step 321, if a predetermined likelihood threshold is reached, the parent computing device 50 is notified and the offending chat text is sent to the parent computing device 50 for review. The chat text in the chat text extraction bucket is destroyed after a predetermined time.

Returning to step 302, if it is determined that the medium of communication is audio and/or microphone, i.e., voice, then execution proceeds to step 304, and then, at step 311, the voice is converted to chat text. Execution then resumes with the chat text at step 320.

If at step 302, it is determined that the medium of communication is a video stream, then execution proceeds to step 306. At step 310, the video stream is split into frames similar to screen shots of step 308. Execution then resumes with the frames to step 308.

At step 314, a determination is made whether the screen capture of step 308 includes an image. If it does not, then execution terminates at step 316; otherwise, execution proceeds to step 318 where the image is processed. At step 328, a determination is made whether the image is Not Safe For Work (“NSFW”). At step 332, if the image is found to be NSFW, execution proceeds to step 334 where it is determined whether the image is Child Sexual Abuse Material (“CSAM”). If at step 334 the image is found to be CSAM, then at step 336, the image is quarantined and a report is generated through Thorn (www.thorn.org) to The National Center for Missing and Exploited Children (NCMEC). A hashed file (not the actual image) is maintained in a highly secured location with extremely limited access for 90 days according to legal statutes.

If at step 328 the image is found to be safe for work, or at step 334, the image is not CSAM, then execution proceeds to step 330 where the image is processed as a potential ML threat. At step 322, the image is processed as a potential combined image and text threat. At step 324, the data from the image ML, text ML, and audio processing is sent to the alert models to determine what if any alerts are needed for the conversation that is being processed. At step 326, alerts are sent to the back end of the subscribing application as necessary. Any alert that contains an image that is flagged as NSFW but not CSAM will have the image not passed unless requested directly by the front end application. Any image that is marked as possible CSAM will NOT be sent to any device. The alerts will indicate that a possible CSAM image was contained within the alert.

Not included on the figures is an ability for an end user to mark a message in a particular category if he believes it to be mismarked. This will generate a message back to an ML development team for evaluation. If this message from the parent is that the image is CSAM, it will automatically quarantine the file and put it in the path for a report to NCMEC.

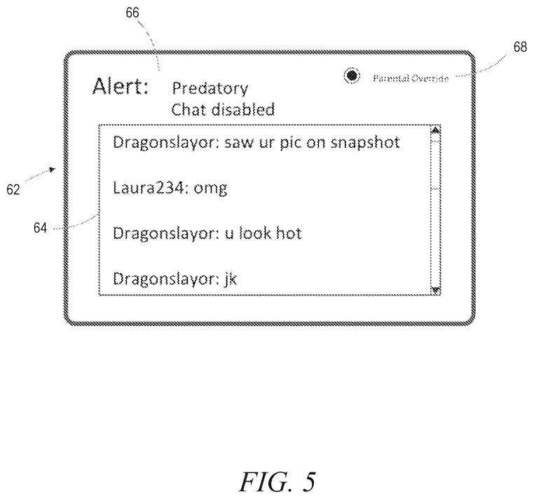

At step 340, the parent computing device displays the notification and offending chat text, as illustrated in FIG. 5. As shown in FIG. 5, example screen 62 displays an alert message 66 along with the actual offending text message 64. In this case, the ML model determined that there was a likelihood that the chat was leading in a sexual direction since one player (Dragonslayer) had commented on a photo that he viewed without apparent knowledge of the child (Laura234), and commented, “u look hot”. However, the player (Dragonslayer) added “jk”, meaning “just kidding”, so reviewing the chat, the parent decided the conversation was innocuous, clicking radio button 68 to override the determination.

At step 342, the parental review is sent back to the cloud computing platform 80 to be used as a training data set to improve accuracy. In the example, an indication as to whether the parent clicked on the radio button 68 is sent to the cloud computing platform.

At step 344, on a determination that the chat constitutes a threat, then a message is sent to disable the child computing device 25 until the parent reviews the offending chat and re-enables it.

Steps 301 and 344 are preferably performed at device management server 20. Steps 340 and 342 are preferably performed at the parental computing device 50. Steps 308 and 309 are preferably performed at the child computing device 25. All other steps are preferably performed at the cloud computing platform 80.

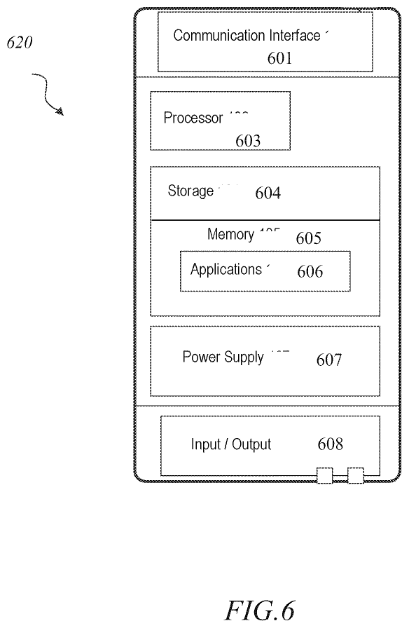

Referring to FIG. 6, a block diagram showing the basic architecture of computing devices usable in conjunction with the present invention is illustrated. As depicted, the example computing device 620 includes a communication interface 601, a processor 603, storage 604, memory 605, a power supply 607, and input/output 608. In an embodiment where the computing device is a smartphone, the communication interface 601 includes a cellular transmitter and receiver. The devices can include a Wi-Fi or ethernet communication interface, for example. Processor 603 includes at least one central processing unit (CPU). The storage 604 can include any suitable hard drive or SSD drive, or in the case of the Cloud-based Platform 80, various bulk storage devices may be used. The memory can include ROM/RAM, flash memory and the like. The power supply 607 can include a re-chargeable battery and power charger, in the case of user devices. Applications 606 are stored in the memory 605, and include program code non-transitorily embedded thereon. This program code includes various programs executable by the processor 603.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. A system for monitoring in-app communication, comprising:
a child computing device including a display, the child computing device being capable of executing one or more user apps and a background application periodically taking samples from what is communicated through the user apps; the one or more user apps including at least one of a gaming app, a messaging app, and a social media app each of which include functionality for generating and communicating at least one of voice, video, and screenshot text;
a parent computing device in communication with the child computing device, the parent computing device executing a parental monitoring application;
a device management server that establishes a master/slave relationship between the child computing device and the parent computing device; and
a cloud computing platform assisting the parental monitoring application that is configured to:
extract samples from the user apps of at least one of voice, video, and screenshot text communicated through the user app;
feed the samples to a machine learning (ML) model to evaluate for threats, including at least one of bullying and predation;
determine a likelihood of one or more threats based on the evaluation; and
notify the parent computing device, if the determined likelihood exceeds a predetermined threshold;
wherein the device management server causes the identified user app executing on the child computing device to be disabled when the determined likelihood exceeds the predetermined threshold.

2. The system for monitoring in-app communication of claim 1, wherein the identified user app is provided to the cloud computing platform by the child computing device.

3. The system for monitoring in-app communication of claim 1, wherein the identified app is determined by the cloud computing platform based on image analysis of one or more of the samples.

4. The system for monitoring in-app communication of claim 1, wherein the machine learning includes one or more of a convolutional neural network (CNN), a recurrent neural network (RNN), a support vector machine (SVM), and a Bayesian Network.

5. The system for monitoring in-app communication of claim 1, wherein the parent computing device allows a parent to override the determined likelihood.

6. The system for monitoring in-app communication of claim 1, wherein the override is used to train the machine learning model.

7. The system for monitoring in-app communication of claim 1, wherein the lack of an override is used to train the machine learning model.

8. The system for monitoring in-app communication of claim 1, wherein, responsive to the override, the device management server causes the identified game to be re-enabled on the child computing device.
